(19) United States
(12) Patent Application Publication
(10) Pub. No.: US 2024/0169662 A1
(43) Pub. Date: May 23, 2024

(54) Latent Pose Queries for Machine-Learned Image View Synthesis

(71) Applicant: Google LLC, Mountain View, CA (US)

(72) Inventors: Seyed Mohammad Mehdi Sajjadi, Berlin (DE); Klaus Greff, Berlin (DE); Etienne François Régis Pot, Berlin (DE); Daniel Christopher Duckworth, Berlin (DE); Mario Lucic, Zurich (CH); Aravindh Mahendran, Berlin (DE); Thomas Kipf, Amsterdam (NL)

(21) Appl. No.: 18/517,190

(22) Filed: Nov. 22, 2023

Related U.S. Application Data
(60) Provisional application No. 63/427,475, filed on Nov. 23, 2022.

(51) Int. Cl. G06T 15/20; B25J 9/16; G06T 7/73

(52) U.S. Cl. CPC G06T 15/205; B25J 9/1697; G06T 7/73; G06T 2207/20081; G06T 2207/20084

(57) ABSTRACT

An example method includes obtaining, by a computing system, one or more source images of a scene; obtaining, by the computing system, a query associated with a target view of the scene, wherein at least a portion of the query is parameterized in a latent pose space; and generating, by the computing system and using a machine-learned image view synthesis model, an output image of the scene associated with the target view.

### PRIORITY

The present application claims priority to and the benefit of U.S. Provisional Patent Application No. 63/427,475 (filed Nov. 23, 2022). U.S. Provisional Patent Application No. 63/427,475 is hereby incorporated by reference herein in its entirety.

### FIELD

The present disclosure relates generally to machine learning. More particularly, the present disclosure relates to training and implementing machine learning models to generate image views of a scene.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model. Novel view synthesis techniques generally involve using a system for generating an image depicting a particular viewpoint of a scene when the system has not been exposed to the scene from the particular viewpoint (i.e., the view is “novel”).

### SUMMARY

Aspects and advantages of embodiments of the present disclosure will be set forth in part in the following description, or can be learned from the description, or can be learned through practice of the embodiments.

In one example aspect, the present disclosure provides an example computer-implemented method for image view synthesis. The example method can include obtaining, by a computing system, one or more source images of a scene. The example method can include obtaining, by the computing system, a query associated with a target view of the scene, wherein at least a portion of the query is parameterized in a latent pose space. The example method can include generating, by the computing system and using a machine-learned image view synthesis model, an output image of the scene associated with the target view.

In another example aspect, the present disclosure provides an example computer-readable non-transitory medium storing instructions executable by one or more processors to cause the computing system to perform various implementations of the example method.

In another example aspect, the present disclosure provides an example computing system that includes the example computer-readable non-transitory medium and the one or more processors.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 is a block diagram of an example image view synthesis framework according to example aspects of some embodiments of the present disclosure;

FIG. 2 is a block diagram of an example image view synthesis framework according to example aspects of some embodiments of the present disclosure;

FIG. 3 is a block diagram of an example image view synthesis framework according to example aspects of some embodiments of the present disclosure;

FIG. 4 is a block diagram of an example image view synthesis framework according to example aspects of some embodiments of the present disclosure;

FIG. 5 is a block diagram of an example image view synthesis framework according to example aspects of some embodiments of the present disclosure;

FIG. 6 provides example results of an example image view synthesis framework according to example aspects of some embodiments of the present disclosure;

FIG. 7 is a flow chart diagram illustrating an example method for executing a machine-learned model according to example implementations of aspects of the present disclosure;

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure;

FIG. 14 is a block diagram of an inference system for operating one or more machine-learned model(s) to perform inference according to example implementations of aspects of the present disclosure;

FIG. 15 is a block diagram of an example networked computing system according to example implementations of aspects of the present disclosure;

FIG. 16 is a block diagram of an example computing device according to example implementations of aspects of the present disclosure; and

FIG. 17 is a block diagram of an example computing device according to example implementations of aspects of the present disclosure.

### DETAILED DESCRIPTION

Example aspects of the present disclosure generally relate to novel view synthesis. Novel view synthesis can include the rendering of an image of a new view of a scene based on other images from other views of the scene. Example aspects of the present disclosure provide a machine-learned image view synthesis model that can generate an image of a target view of a scene based on one or more source images of the scene. The target view can be specified at inference time with a query. The query can be parameterized in a latent pose space that is learned during training (e.g., based on a reconstruction loss). For instance, the latent pose space can be learned by training a pose estimator model and the image view synthesis model to respectively generate and process the query to capture, in the latent space, pose information associated with a training image. Advantageously, the machine-learned image view synthesis model can learn the latent pose space without explicit ground-truth pose data. In this manner, for instance, example aspects of the present disclosure can provide for novel view synthesis at lower cost with relatively inexpensive training data.

Implicit learned latent representations of scenes can demonstrate remarkable abilities to capture the 3D structure of complex real-world scenes while overcoming many of the challenges with mesh based, point cloud based, and voxel grid based representations. Apart from visually pleasing novel view synthesis, such representations can be applied for semantic parsing of scenes, object decomposition, physics simulation, etc. Such representations can thus have myriad utility in augmented reality and robotics. Advantageously, example implementations of the present disclosure can provide such utility while operating on relatively low amounts of training/input data and while operating with relatively low latency (e.g., for real-time rendering).

Some existing approaches that use learned scene representations require costly training data. For example, many such approaches require accurate pose information for learning the scene representations. This can be cost prohibitive or impossible in many real-world situations. Even if pose information can be available from various sensors (e.g., GPS transponders and gyroscopes in in camera devices), the signals can have limited precision and suffer from noise. Such imperfections in pose information can affect overall performance of such prior methods.

In contrast, example implementations of the present disclosure can provide for truly pose-free model training (e.g., using images alone without requiring any ground truth pose information). Example implementations of the present disclosure can provide for novel view synthesis that does not require any pose information: neither for training, nor for inference; neither for input views, nor for target views.

During training, in lieu of ground truth pose information, example implementations of the present disclosure can be trained by using a portion of a training target view of a scene to compute a latent pose signal. This latent pose signal can then be used as a query for decoding a latent representation of a scene to generate a novel view. In this manner, for instance, the image view synthesis model can learn a latent pose space in conjunction with a learned latent representation of the scene itself. This latent pose space can facilitate generation of target views. Advantageously, example image view synthesis models according to the present disclosure can learn meaningful, controllable latent pose spaces. The quality of novel views generated from example models of the present disclosure can be comparable to existing prior techniques when such prior techniques are provided clean pose information. However, by avoiding dependence on pose information, the quality of novel views generated from example models of the present disclosure can significantly exceed the performance of existing prior techniques when such prior techniques are provided noisy or otherwise imperfect pose information.

Example aspects of the present disclosure can provide a number of technical effects and benefits. For instance, techniques according to the present disclosure can provide for training machine-learned image view synthesis models using relatively low-cost training data without requiring explicit pose data in the training or test datasets. For instance, ground-truth explicit pose data can be expensive to obtain, especially in real-world environments. Advantageously, example implementations according to the present disclosure can be trained based on one or more images of a scene, optionally without explicit pose data describing the relative or absolute poses of the images.

Additionally, example image view synthesis frameworks according to the present disclosure can exhibit improved robustness to noisy inputs and noisy training data. For instance, leveraging a latent pose space according to the present disclosure can provide improved stability of pose queries and outputs in view of noise in the input(s). For instance, improved robustness to noisy inputs can facilitate improved performance in real-world implementations, such as robotics navigation, industrial process imaging, autonomous vehicles, etc.

A technical effect of example implementations of the present disclosure is increased energy efficiency in performing operations using machine-learned models, thereby improving the functioning of computers implementing such models. For instance, example implementations can provide for more energy-efficient training by avoiding costly and labor-intensive sample collection and labeling. In some scenarios, increased energy efficiency can provide for less energy to be used to perform a given task (e.g., less energy expended to train the model, etc.). In some scenarios, increased energy efficiency can provide for more task(s) to be completed for a given energy budget (e.g., more training for a given amount of energy, such that per-iteration training cost is lower, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Example aspects of the present disclosure are discussed herein in reference to the enclosed figures.

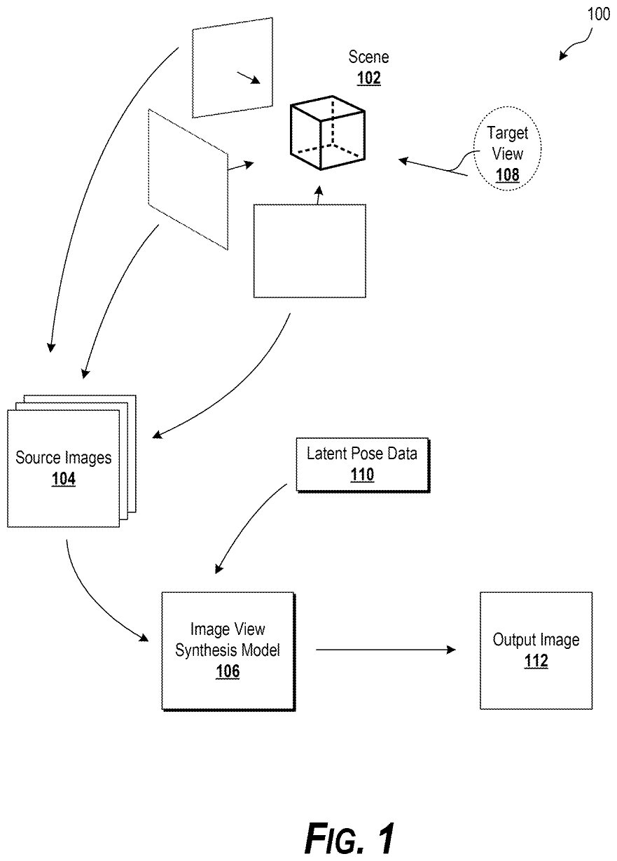

FIG. 1 is a block diagram of an example image view synthesis framework 100 according to example aspects of some embodiments of the present disclosure. To generate a novel view of a scene 102, the framework 100 can process source images 104 that describe at least a portion of scene 102. For instance, source images 104 can include images that depict scene 102 from different views. Image view synthesis model 106 can ingest source images 104 to build an understanding of scene 102. To generate an image associated with a desired target view 108, framework 100 can obtain latent pose data 110 that corresponds to target view 108. Image view synthesis model 106 can use latent pose data 110 to draw upon its learned understanding of scene 102 generate an output image 112 that is associated with the target view 108 (e.g., an image depicting target view 108 of scene 102).

Image view synthesis framework 100 can be implemented on one or more computing devices or systems. Image view synthesis framework 100 can be implemented in a variety of different contexts. In general, image view synthesis framework 100 can be implemented in any suitable image processing pipeline on distributed or local computing systems.

In an example, image view synthesis framework 100 can be employed in the creation of virtual reality (VR) and augmented reality (AR) experiences. Generating realistic views of a scene from various angles can help provide a realistic and immersive experience for users. Framework 100 can be used to generate these views from an inexpensive set of source images, potentially reducing the amount of data or other resources used to create a realistic VR or AR environment, thereby improving the efficiency of such systems. Additionally, the framework's ability to generate views without reliance on explicit, clean pose data can allow for more flexibility in creating AR and VR experiences with limited reference data as well as improving an experience using lower-cost (e.g., noisier) pose-tracking sensors.

In an example, image view synthesis framework 100 can be used for static animation content (e.g., audiovisual recordings) or interactive animated content (e.g., video games). Framework 100 can allow users to create a multitude of perspectives of a scene with a reduced amount of manual input and less reliance on expensive pose data. This can allow the creation of a more immersive and dynamic content by rendering different perspectives of a scene (e.g., interactively based on a player's actions).

In an example, image view synthesis framework 100 can also be used for robotic perception and motion control. For instance, framework 100 can generate views of a scene from various perspectives based on images captured by cameras or other sensors of the robot or in the robot's environment. This can provide a comprehensive representation of the surroundings that can be used to reason over perspectives of a scene that might not be directly represented in an initial source image set. This can enable the robot to navigate its environment more effectively and to perform tasks such as object manipulation with greater accuracy. The ability of the framework to generate views without explicit pose data can also be beneficial in robotic applications, as it can allow the robot to generate accurate views of its environment even when its sensors fail to provide precise pose information.

Additionally, or alternatively, the strong latent representations with learned pose signals can be used by a robotic system as an input layer interfacing between a decision-making system and a perception system. For example, a learned latent scene representation can be used as an input to another machine-learned model that is configured to reason over the scene and generate one or more actions for responding to the environment or scene.

Scene 102 can be any object, environment, or setting represented by source images 104. Scene 102 can be a real-world scene or an artificial scene. Scene 102 can be a human-interpretable scene (e.g., a scene of objects recognizable or otherwise interpretable by humans). Scene 102 can include any data that can be projected into multiple projections (e.g., with the novel view task being to generate a new projection of the data).

An example scene includes a real-world environment as perceived by a robot. The scene can include a controlled environment (e.g., a factory) or an uncontrolled environment (e.g., a busy sidewalk or street). An example scene includes a real-world environment as perceived by a user device. For instance, an example scene includes a real-world environment that a user is interacting with. It could be the living room where a user is playing an augmented reality game, or it could be a city street where a user is using an augmented reality navigation app. In these scenarios, example implementations of the present disclosure can generate novel views of scene 102 in real-time, providing the user with a seamless and immersive augmented reality experience. The generated novel views can help the user explore the augmented reality environment from different perspectives, enhancing the feeling of immersion and improving the overall user experience.

An example scene includes a medical subject imaged by a medical imaging device. The present disclosure can be used to synthesize novel views of the subject that are not directly present in the original images. This can provide enhanced visualization of the anatomy or pathology of interest, potentially assisting radiologists or other medical professionals in diagnosis and treatment planning. The ability to generate novel views without explicit pose data can be particularly advantageous in medical imaging, where the pose of the scanned subject can vary widely and may not be precisely known (e.g., such as in telehealth applications where an initial capture could be recorded in an uncontrolled environment at a patient's location).

Source images 104 can include one or more images recorded or captured from different views of scene 102. These images can be collected from any device or system with an imaging or other perception sensor. They may also be generated by computer graphics software or obtained from existing databases or collections of images. Source images 104 can include one or multiple value channels (e.g., grayscale, RGB, alpha, etc.).

Source images 104 can be of various resolutions. Source images 104 can all be of the same resolution. Source images 104 can include a set of images having varied resolutions.

Each of the source images 104 can contain data describing a different perspective or viewpoint of scene 102. For instance, the images can correspond to viewpoints having different distances and orientations with respect to a reference or origin of scene 102. This variety in views can provide the image view synthesis model with a comprehensive understanding of the scene, enabling it to generate accurate and realistic novel views. Source images 104 can include both foreground and background elements of the scene. Source images 104 can capture various lighting conditions, colors, textures, and shapes.

Source images 104 can be preprocessed before being provided to image view synthesis model 106. Preprocessing can involve operations such as image resizing, normalization, augmentation, or other transformations. Preprocessing can help to standardize the input data, enhance certain features of the images, or increase the robustness and generalizability of the image view synthesis model.

For example, source images 104 can include variations of image attributes that are unrelated to scene 102. For example, source images 104 can include multiple images of the same or similar views that are varied in coloration (e.g., white balance), brightness (e.g., exposure), noise, etc. In this manner, for instance, image view synthesis model 106 can learn to encode the geometry of scene 102 with invariance to the attributes of the image(s) themselves. Additionally, or alternatively, latent pose data 110 can include a learned dimension that corresponds to one or more image attributes (e.g., white balance, exposure, etc.), such that novel views can be generated that possess various image attributes.

In various implementations, source images 104 can be captured by imaging sensors on mobile devices, robotics devices, autonomous devices, etc. Source images 104 can be captured and processed locally or externally on a server to obtain images of other views of the scene. Source images 104 can be frames of a video capture. The framework 100 can execute in batch processing or in real-time streaming (e.g., for robotic perception, etc.). Computing systems can perform novel view synthesis as a service (e.g., via an API).

Image view synthesis model 106 can include one or more machine-learned models or model components. Image view synthesis model 106 can include one or more convolutional neural networks or convolutional layers. Image view synthesis model 106 can include one or more transformer blocks. Image view synthesis model 106 can include a diffusion model architecture.

Image view synthesis model 106 can process source images 104 and, in view of latent pose data 110, generate a novel view of scene 102. Image view synthesis model 106 can obtain values that encode a latent representation of scene 102. Image view synthesis model 106 can generate the latent scene representation based on source images 104. Image view synthesis model 106 can use latent pose data 110 to effectively query the latent scene representation to generate a novel view responsive to the query.

The latent scene representation can have fixed or variable dimensions. The latent scene representation can be stored as a tensor or other data object. The latent scene representation can be a uniform set of values generated to represent scene 102. The latent scene representation can be a subdivided set of values that represent different aspects of scene 102. For instance, the latent scene representation can identify latent encoding data associated with one or more individual source images of source images 104. For example, at least one image can be used as a reference image setting an origin or anchor viewpoint (e.g., a first image in a sequence of images).

Image view synthesis model 106 can leverage an encoder-decoder architecture. An encoder can process source images 104 to generate the latent scene representation. The encoder can include, for example, a convolutional neural network configured to generate feature maps from source images 104. For example, a convolutional neural network can process each source image independently to generate one or more features maps for each image.

Features in the feature maps (e.g., individual “pixels” of the feature map, such as a spatial 2D coordinate with which one or more channels of data are associated) can be augmented with one or more other data types. For example, position embeddings can be added to each feature or to groups of features (e.g., to the feature map as a whole) to indicate a spatial relationship with the original image (e.g., pointing to a location of the original image that the feature map describes). The position embeddings can be learned or learnable. An embedding can be added to features of an image to designate those features as corresponding to a reference image that sets an origin or anchor viewpoint (e.g., a first image in source images 104). The embedding can be a learned or learnable embedding.

An encoder can include additional learned components that generate a latent scene representation from the feature map(s). For example, a sequence processing model can process a sequence of input elements corresponding to the feature map(s). For example, one or more feature maps can be flattened and serialized. The features maps from all source images 104 can be flattened and combined into a set of input elements (e.g., tokens) that can be processed as an input sequence using a sequence processing model (e.g., a transformer-based model).

A sequence processing model or model component of the encoder can attend over the sequence to exchange and propagate information across the features. For example, a transformer-based attention layer can attend over the input sequence and generate updated element values. The attention layer can perform self-attention over the input sequence. The updated element values can pass to another transformer-based attention layer (which can be the same or different as the first) that can attend over the updated element values to generate further updated element(s). In this manner, for instance, a latent scene representation can include elements that encode information about a portion of the scene with respect to other portions of the scene. For example, the latent scene representation can be a set of updated elements output by a transformer block (e.g., a “bag of tokens”).

Image view synthesis model 106 can include a machine-learned decoder model or model component that can process the latent scene representation and generate an output image 112 that corresponds to the scene. For example, the machine-learned decoder model can be configured to generate image data based on the latent scene representation. For example, the machine-learned decoder model can generate pixel data (e.g., color values, brightness values, etc.) for pixels of an image. The machine-learned decoder model can generate image data describing one pixel or a patch of multiple pixels in a single forward pass. For instance, the machine-learned decoder model can include a diffusion model architecture that generates image data conditioned on the latent scene representation as context. The machine-learned decoder model can include a regression model architecture that regresses one or more values for one or more channels of an output image (e.g., for one or more pixels of an output image).

An example machine-learned decoder model can include one or more transformer-based attention layers that can attend over the latent scene representation to extract scene information related to a query. The query can include one or more latent pose parameters (e.g., a query based on latent pose data 110). The query can include a target position for the output (e.g., a 2D position of a pixel in the output image). An attention layer of the decoder can cross-attend between the query and the latent scene representation. The attention layer can process the latent scene representation and the query to pass information from the latent scene representation into an updated query representation.

The machine-learned decoder model can process a hidden state of the decoder (e.g., one or more intermediate output(s) of one or more internal transformer-based attention layers) using one or more output layers. The output layers can include, for instance, a feedforward network, such as a multilayer perceptron. The feedforward network can output one or more channel values for an output image (e.g., an RGB value for a pixel, such as the pixel corresponding to the target position indicated in the query).

Target view 108 can include any desired perspective or viewpoint from which an image of a scene is to be generated. Target view 108 can be constrained or unconstrained. For instance, target view 108 can be constrained to viewpoints or fields of view within a threshold distance or difference from viewpoints or fields of view represented in source images 104.

Target view 108 can correspond to a novel view of scene 102. For instance, target view 108 can correspond to a view of scene 102 that is different from views represented in source images 104. Target view 108 can correspond to a different incident direction of an incident ray toward of scene 102. Target view 108 can correspond to a different viewpoint from which an incident ray originates (e.g., having the same or different ray direction).

To cause image view synthesis model 106 to generate an output image depicting a novel view that corresponds to target view 108, image view synthesis model 106 can process a latent scene representation in view of latent pose data 110.

Latent pose data 110 can include latent pose values that, when ingested by image view synthesis model along with a latent scene representation, can cause image view synthesis model 106 to generate image data that is associated with a pose parameterized in the latent pose space. Latent pose data 110 can include a tensor of one or more values that correspond to dimensions of a latent pose space.

For example, image view synthesis model 106 can learn an implicit pose space of camera poses using a pose estimator model. A pose estimator model can, during training, estimate a latent pose query associated with a training output image. For instance, one or more portions of a training output image can be processed by the pose estimator model to generate a pose parameterized in the latent pose space (e.g., so that the output image corresponds to the same view as the training output image to facilitate evaluation during training).

The pose estimator model can include a convolutional neural network configured to generate feature maps from the one or more portions of the training output image. For example, a convolutional neural network can process a region (e.g., a quadrant, a half, a patch, etc.) of the training output image to infer an orientation of the view associated with that image. Features in the feature maps (e.g., individual “pixels” of the feature map, such as a spatial 2D coordinate with which one or more channels of data are associated) can be augmented with one or more other data types. For example, position embeddings can be added to each feature or to groups of features (e.g., to the feature map as a whole) to indicate a spatial relationship with the original image (e.g., pointing to a location of the original image that the feature map describes). The position embeddings can be learned or learnable.

The pose estimator model can include additional learned components that generate a latent poser from the feature map(s). For example, a sequence processing model can process a sequence of input elements corresponding to the feature map(s). For example, one or more feature maps can be flattened and serialized. The features maps from the training output image can be flattened and combined into a set of input elements (e.g., tokens) that can be processed as an input sequence using a sequence processing model (e.g., a transformer-based model).

A sequence processing model or model component of the pose estimator model can attend over the sequence to exchange and propagate information across the features. A sequence processing model or model component of the pose estimator model can cross-attend over the sequence and the latent scene representation to determine how the training target image is oriented with respect to the scene. For example, a transformer-based attention layer can attend over the input sequence and generate updated element values. The attention layer can perform self-attention over the input sequence. The updated element values can pass to another transformer-based attention layer (which can be the same or different as the first) that can attend over the updated element values to generate further updated element(s). The hidden state can be projected to a desired output format, such as a tensor containing latent pose data 110.

Image view synthesis model 106 can generate output image 112 by querying over the latent scene representation using a query that contains latent pose data 110. Image view synthesis model 106 can generate output image 112 by processing one or multiple queries associated with a given set of latent pose data. For example, a given set of latent pose data can define a target view. Image view synthesis model 106 can process a query for that target view for each position in a desired output image (e.g., each pixel, each patch, etc.) to obtain value(s) of the image at those location(s).

Output image 112 can include any variety of image data that can be the same format as or a different format from source images 104. Output image 112 can include a complete image or a part of an image or a layer to be overlaid another image.

Output image 112 can be further processed after generation. For example, an image processing model can increase a resolution or detail in output images 112. Another machine-learned model can use output images 112 as context. For example, a machine-learned sequence processing model can process output image 112 in combination with natural language inputs to answer questions or otherwise follow instructions regarding scene 102.

Image view synthesis framework 100 can pass output image 112 to other downstream systems. Image view synthesis framework 100 can pass output image 112 to a robotics perception system. Image view synthesis framework 100 can pass output image 112 to an augmented reality or virtual reality system. Image view synthesis framework 100 can pass output image 112 to a display device for displaying output image 112.

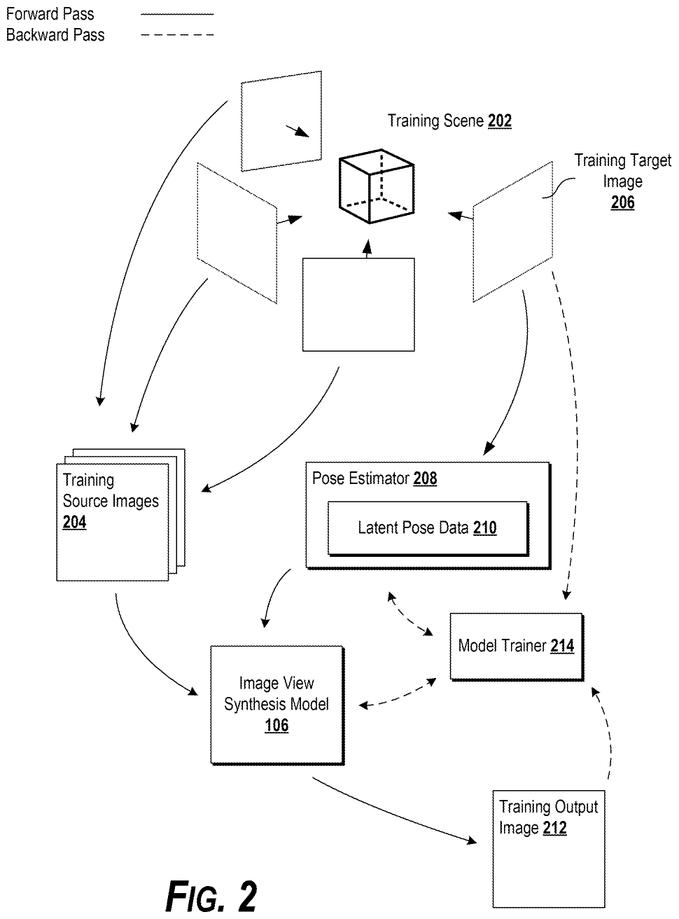

FIG. 2 is a block diagram of a process flow for training an example image view synthesis framework 100 according to example aspects of some embodiments of the present disclosure. A forward pass can use a set of training data associated with a training scene 202. Training data can include training source images 204 and training target image(s) 206 which depict training scene 202 from different views. Training pose generator 208 can generate, using training target image 206, latent pose data 210 to feed into image view synthesis model 106. Based on training source images 204 and latent pose data 210, image view synthesis model 106 can generate a training output image 212.

In a backward pass, a model trainer 214 can evaluate training output image 212 against training target image 206 (e.g., with a reconstruction loss, or other loss or score). Model trainer 214 can update one or more parameters of image view synthesis model 106 or training pose generator 208 based on the evaluation to improve the performance of image view synthesis model 106. In this manner, for instance, framework 100 can be trained without explicit pose data in the training data, instead using “sneak peeks” of the target view to discern the desired pose using pose generator 208.

Advantageously, image view synthesis model 106 can learn a meaningful structure in the latent pose space without any form of camera pose supervision. For instance, the latent pose space can naturally reflect semantically meaningful axes with respect to camera views (e.g., camera height, camera rotation, camera distance, etc.). This can allow test-time pose control directly in the latent space. For example, linear latent pose traversals can correspond to translation, pitch, and tilt of a camera. These dimensions can be mapped into the pose space predictably, contiguously, and smoothly. The correct parallax effect observed in the forward movement can demonstrate that the model has correctly estimated the depth of the scene. In this manner, for example, implementations of the present disclosure can learn to capture the 3D structure of complex real-world scenes from a handful of images, without access to any pose information. The learned latent pose space can cover the training distribution of camera poses and enables traversals and novel view synthesis within distribution (or out of distribution).

Training scene 202 can include a scene such as scene 102. Training source images 204 can include images such as source images 104.

Training target image 206 can include a ground truth image representing a target view of training scene 202. Pose generator 208 can process all or part of training target image 206 to generate latent pose data 210.

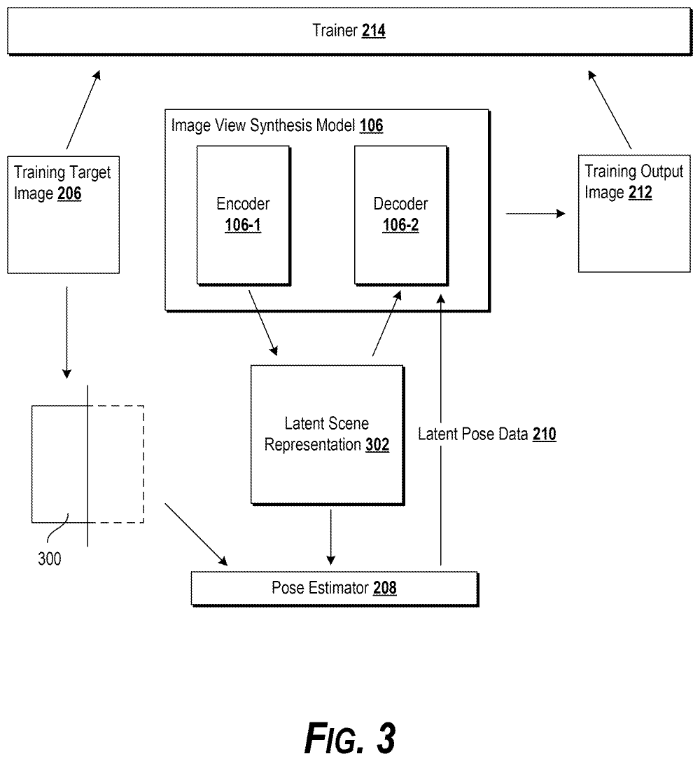

FIG. 3 is a block diagram of an example training system for training image view synthesis model 106. A target image hint 300 can be extracted from training target image 206. For example, target image hint 300 can include half of training target image 206. Pose estimator 208 can process target image hint 300 in view of a latent scene representation 302 generated by image view synthesis model 106 (e.g., generated by an encoder 106-1). Pose estimator 208 can generate latent pose data 210 based on target image hint 300 and latent scene representation 302. Image view synthesis model 106 can process latent pose data 210 in view of latent scene representation 302 (e.g., using a decoder 106-2) to generate training output image 212. Trainer 214 can process training output image 212 can evaluate it against all or part of training target image 206 (e.g., a portion of training target image 206 that was omitted from target view hint 300).

Target view hint 300 can include a portion of training target image 206. The portion can be a patch of one or more pixels extracted from training target image 206. The portion can be a masked or corrupted version of training target image 206 (e.g., resulting from a noise-based mask). The portion can be half of training target image 206. The location of the portion (e.g., which quadrant, which half, etc.) can be probabilistically determined for each training example. The location of the portion can be constant over one or more training examples.

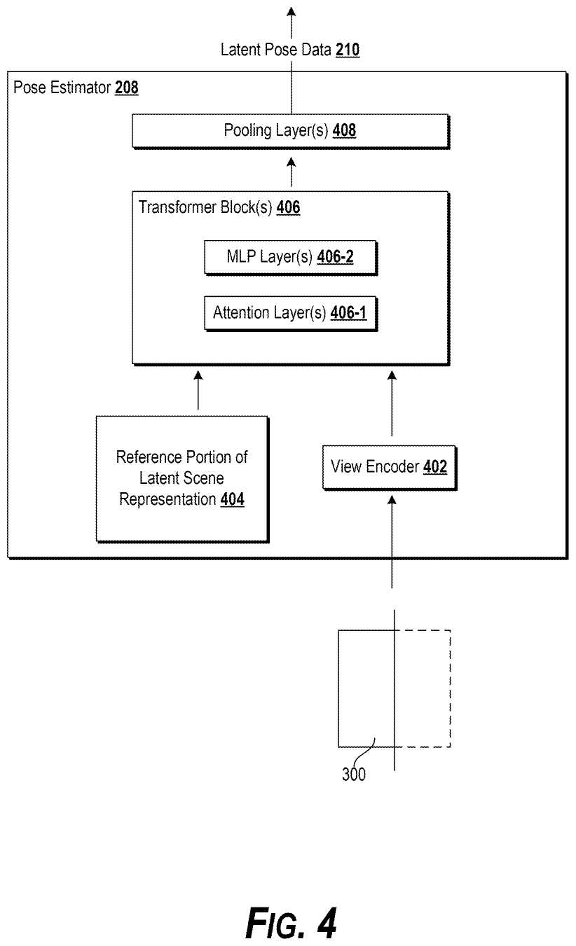

FIG. 4 is a block diagram of an example pose estimator 208 according to example implementations of the present disclosure. Pose estimator 208 can include a view encoder 402 that processes target view hint 300. Pose estimator 208 can also receive a reference portion of the latent scene representation 404 that can anchor an orientation for the generated latent pose. Pose estimator 208 can include one or more transformer blocks 406 that can include attention layer(s) 406-1 and feedforward layer(s) 406-2. Pose estimator 208 can include pooling layer(s) 408. Pose estimator 208 can output latent pose data 210.

View encoder 402 can include an encoder similar to encoder 106-1 of image view synthesis model 106. View encoder 402 can process an input image portion and generate a sequence of elements that can be cross-attended with at least a portion of the latent scene representation. View encoder 402 can include a convolutional neural network and one or more transformer-based attention layers, similar to an encoder for image view synthesis model 106.

Reference portion of latent scene presentation 404 can include a portion of the latent scene representation (e.g., representation 302) that corresponds to an anchor or reference viewpoint. The selection of a latent embedding of a particular view can provide a consistent reference point relative to which pose estimator 208 can estimate pose. This can help the model learn a more intuitive and semantically relevant latent pose space. For instance, reference portion 404 can be a portion of the latent scene representation that corresponds to a designated reference image, such as an image that has an extra embedded feature to designate it thus. For example, reference portion 404 can be a portion of the latent scene representation that corresponds to a first image of training source images 204.

Transformer blocks 406 can cross-attend over the embedded target view hint with respect to reference portion 404. Transformer blocks 406 can also apply self-attention over the embeddings. For example, sequential attention layers can include one layer (e.g., a first attention layer) employing cross-attention between the embedded target view and the latent scene representation and another layer (e.g., a second attention layer) employing self-attention over the updated embedding for the target view hint (e.g., the updated embedding having received information from the latent scene representation as a result of the first cross-attention layer). A transformer block can generate an output using a feedforward network, such as with one or more multilayer perceptron or feedforward layer(s) 406-2.

Pose estimator 208 can include one or multiple transformer block(s) 406. Pose estimator 208 can include, for example, three transformer block(s). Each transformer block can include the same or different structures. Each transformer block can use the same or different learned parameters.

Pose estimator 208 can be used during training to cause image view synthesis model 106 to generate a training output image 212 that aligns with a training input image 204.

Pose estimator 208 can be used at inference time to process known “helper” images to initiate generation of novel views that are based on the helper images. The query or the latent pose values can be based on an interpolation between other anchors in the latent space. For instance, helper images can provide anchors for navigating through the latent space to a pose that gives an image viewpoint “between” the viewpoints of the helper images. For instance, the framework 100 can process multiple helper images (e.g., with a pose generator/estimator or view navigator) to obtain latent pose values associated with the helper images. The latent pose values associated with the helper images can be vectors in the latent pose space. Obtaining a set of target pose values can include interpolating between/among the latent pose values associated with the helper images. In this manner, for instance, the framework can generate an output image using interpolation.

For example, image view synthesis model 106 can generate a latent scene representation that corresponds to a latent pose space. Known images can capture view of a scene from two viewpoints, but it may be desired to obtain images from multiple viewpoints near to those viewpoints (e.g., distributed between the two viewpoints, etc.). Pose estimator 208 can generate latent pose data for each of the two known images and use the latent pose data to establish anchors. Then image view synthesis model 106 can be instructed using latent pose data interpolated between the anchors to obtain novel views that represent views interpolated between the two views reflected in the two anchor images. This can be used, for example, for artificially increasing or smoothing a framerate of video content (e.g., interpolating between two frames), time-aligning image data with different capture frequencies, etc.

This can also be used to enforce view generation within a high confidence region. For example, in some scenarios views between two known references or source images can provide a lower likelihood of occlusions as compared to views of the same scene that might be opposite all the source imagery. For instance, a scene can be captured in two images that are 30 degrees apart. A high confidence novel view can be generated for a target view within the 30 degree included angle. A novel view that is oriented from the opposite direction in the scene can be lower confidence, as the system may not have had any opportunity to observe the other side of the scene.

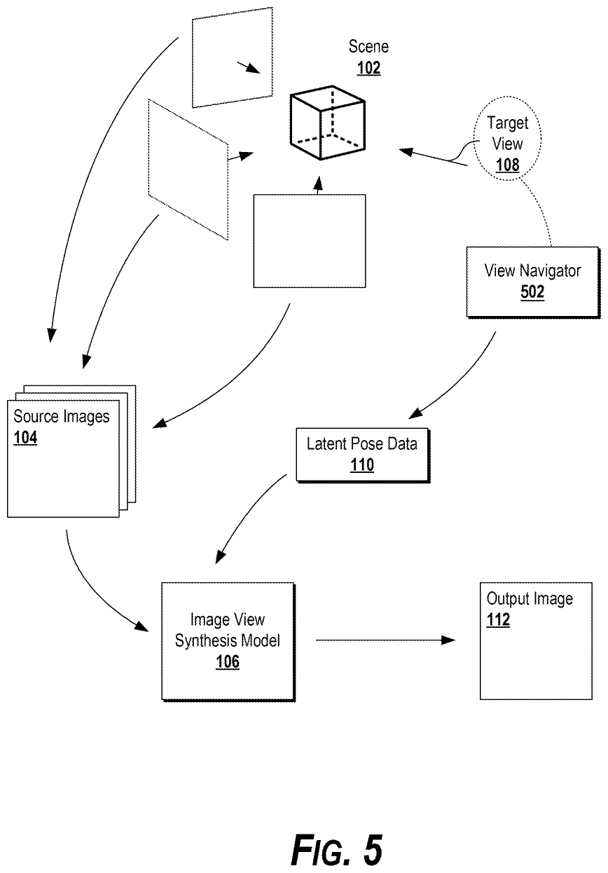

FIG. 5 is a block diagram of an example image view synthesis framework using a view navigator 502 according to example aspects of some embodiments of the present disclosure. View navigator 502 can navigate the latent pose space to generate latent pose data 110. For instance, view navigator 502 can provide one or more interactive elements (e.g., via a user interface of a user device) that can be configured to manipulate latent pose data along various dimensions.

For instance, view navigator 502 can process the latent pose space to determine effectual axes for manipulating the pose data. For instance, a latent pose space can be multidimensional. View navigator 502 can traverse the latent pose space and determine the effect of the different latent pose values on the output image 112. For instance, view navigator 502 can vary the latent pose values (e.g., along an arbitrary axis) and determine that the direction of movement in the latent pose space corresponds to a rotation, a translation, etc. View navigator 502 can determine directions of motion of interest using, for example, a principal component analysis of the latent pose space.

View navigator 502 can obtain user feedback for confirming axes of interest. View navigator 502 can present a dashboard interface that provides animations or videos reflecting latent pose value movement in association with the interactive element that controls that latent pose value movement. For example, above a slider that causes the latent pose values to adjust along a particular axis, view navigator 502 can render a preview or animation of the output image reflecting adjustments to the latent pose values along that particular axis.

View navigator 502 can use a machine-learned model to predict what camera control corresponds to the adjustments along that axis (e.g., determine that the direction of movement in the latent pose space corresponds to a rotation, a translation, etc.). View navigator 502 can receive an input indicating that the prediction was correct or incorrect. For instance, view navigator 502 can receive, from a user device, an input indicating that the prediction is correct or incorrect. In this manner, for instance, view navigator 502 can be trained to improve its performance in predicting semantically meaningful descriptions for traversal of axes of the latent pose space (or a projection thereof).

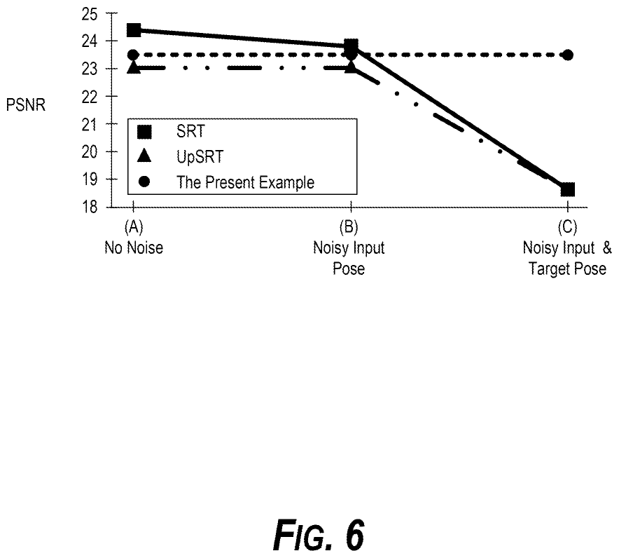

FIG. 6 and the tables below provide some example results from some example tests of an example implementation according to the present disclosure. Various features of the example implementation of the present disclosure used for testing are described herein.

For this example, in The Present Example, a data point can consist of an unordered set of N input views x={xi∈RH×W×3} of a scene. The data points can consist of RGB images since The Present Example does not necessarily need explicit poses. Given these input views, in The Present Example the training objective can be to predict a novel target view y∈RH×W×3 of the same scene. To this end, in The Present Example, the input views x are first encoded using a combination of a CNN and a transformer, resulting in the Set-Latent Scene Representation (SLSR) S which captures the contents of the scene.

In The Present Example, the target view y is then rendered by a transformer-based decoder that attends into the latent scene representation S to retrieve relevant information about the scene for novel view synthesis. In addition, in The Present Example, the decoder can be conditioned on some form of a query that identifies the desired view. In The Present Example, image view synthesis model 106 learns its own notion of implicit poses.

Instead of querying the decoder with explicit poses, in The Present Example, the model is allowed to learn its own implicit space of camera poses through a learned Pose Estimator 208. For training, Pose Estimator 208 can see parts of the target view y and the latent scene representation S and extract a low-dimensional latent pose feature p^{˜}. The decoder transformer can then use p^{˜} as a query to cross-attend into the latent scene representation S to ultimately render the full novel view y^{˜}. This form of self supervision can allow the model to be trained with standard reconstruction losses without requiring any pose information. At test time, latent poses can be computed on the input views and subsequently modified for novel view synthesis. At runtime, latent poses can be mapped to an intuitive search space by conducting a principal component analysis.

In The Present Example, a view encoder contains a convolutional neural network (CNN) followed by a transformer. Each input image xi can be encoded independently by the shared CNN which can include 3 downsampling blocks, each of which halves the image height and width. As a result, each spatial output feature can correspond to an 8×8 patch in the original input image. The same learned position embeddings can be added to all spatial feature maps to mark their spatial 2D position in the images. Another learned embedding can be added to the features of the first input image x₁ to allow the model to distinguish them from the others. This can be relevant for Pose Estimator 208, as explained herein.

All spatial feature maps can be flattened and combined across input views into a single set of tokens. The encoder transformer can then perform self-attention on this set of tokens, thereby exchanging information between the patch features. This results in the SLSR S which captures the scene content as a bag of tokens.

In the Present Example, a randomly chosen half of the target view y (i.e., either the left or the right half of the image) is processed by Pose Estimator 208. The half can be first embedded into a set of tokens using a CNN similar to the input view encoder. In the Present Example, the CNN in the Pose Estimator follows very similar structure as the CNN in the encoder, with two exceptions: 4 CNN blocks are used to obtain 16×16 patches, and image id embeddings are omitted, as each target view is processed and rendered fully independently. The transformer follows the same structure as the encoder transformer 768 features are used for the attention process and 1536 features are used in the MLPs and pre-normalization is used.

In the Present Example, a transformer then alternates between cross-attending from the target view tokens into a specific subset S^{˜}⊂S of the SLSR and self-attending between the target view tokens. The intuition behind cross-attending into S^{˜} is that the latent pose p^{˜} can be thus determined relative to the scene. In the Present Example, Pose Estimator 208 attends only into SLSR tokens belonging to the (arbitrarily chosen) first input view. Empirical testing shows that this can lead to better structured latent pose spaces. Even S^{˜} can contain information about all input views due to the self-attention in the preceding encoder transformer.

In the Present Example, Pose Estimator 208 can apply global mean pooling on the transformer's output and linearly project it down to an 8-dimensional latent pose p^{˜}. The value p^{˜} can be referred to as the estimated “pose” since it can inform the decoder of the target camera pose. However, in the Present Example there are no explicit constraints on the latent, instead allowing the model to freely choose the structure of the latent poses. Nevertheless, image view synthesis model 106 can learn to model meaningful camera poses.

In the Present Example, each pixel can be decoded independently by a decoder transformer that cross-attends from a query into the SLSR S, thereby aggregating relevant information from the scene representation to establish the appearance of the novel view. The query can be initialized by concatenating the latent pose p^{˜} with the spatial 2D position of the pixel in the target image and passing it through a small query MLP. The output of the decoder in the Present Example can be the single RGB value of the target pixel.

For training the Present Example, 5 input views and 3 novel target views are used for each data point during training. The training objective is to render the target views by minimizing the mean-squared error between the predicted output and the target view: ∥y^{˜}−y∥₂². The entire model can be trained end-to-end using the Adam optimizer. In the Present Example, gradients flowed to and through the Pose Estimator 208. The gradients were scaled down by 0.2.

All models used to obtain the example results described herein were trained for 3 M steps with batch size 256 on MSN dataset and 128 on SV dataset.

Example tests of the Present Example include measuring the quality of synthesized novel views in new scenes under various assumptions on the accuracy and availability of camera pose information during training. To simulate the real world, the tests perturb the training camera poses with additive noise for a relatively mild amount of σ=0.1. In the present tests this leads to three possible settings for both input poses and target poses: perfect (pₓ, p_{y}), noisy (p_{x (noisy)}, p_{y (noisy)}) and lack of pose (none). For the posed baselines, the present tests use perfect target poses for evaluation, i.e. the target poses are only perturbed during training.

Table 1 provides quantitative evaluation on the MSN dataset. Here, SRT and UpSRT refer to pose-dependent implementations of the encoder and decoder used in the Present Example, with pose dependency incorporated as taught by Sajjadi et al., Scene Representation Transformer: Geometry-Free Novel View Synthesis Through Set-Latent Scene Representations, arXiv:2111.13152v3 [cs.CV] 29 Mar. 2022, which is hereby incorporated by reference herein in its entirety.

TABLE 1
Results over MultiShapeNet DataSet

| Method | Pose | PSNR |
|---|---|---|
| SRT | Pₓ, P_{y} | 24.40 |
| | P_{x (noisy)}, P_{y} | 23.81 |
| | P_{x (noisy)}, P_{y (noisy)} | 18.65 |
| UpSRT | P_{y} | 23.03 |
| | P_{y (noisy)} | 18.64 |
| The Present | none | 23.49 |
| Example | | |

Notably, a realistic setting where all poses are noisy leads to a dramatic decline in performance for prior work (SRT and UpSRT). The Present Example meanwhile outperforms the baselines by +4.84 dB in this setting without any poses. FIG. 6 highlights the difference between only perturbing input poses or all camera poses.

An explicit pose recovery test was conducted to demonstrate how the latent scene representation encodes meaningful pose information. A machine-learned model was trained to process the latent scene representation and two latent poses for two target views and output an explicit relative pose therebetween. The model takes the SLSR S and the latent pose features p^{˜}1 and p^{˜}2 for the two target views and follows the design of the image view synthesis model decoder: the concatenation of the two latent poses acts as the query for a transformer which cross-attends into the SLSR S. The result is passed through an MLP which is tasked to predict the explicit relative pose between the target views. The model is trained using the L2 loss.

As shown in Table 2, the Present Example recovers relative camera poses nearly perfectly from the SLSR (5 input views) and the pair of latent target poses. COLMAP (from Schonberger et al., Structure-from-Motion Revisited, CVPR 2016) requires a much larger number of images, and still has a significantly lower success rate for registration. Similarly, GNeRF (from Quan Meng, GNeRF: GAN-Based Neural Radiance Field Without Posed Camera. In ICCV, 2021) requires many views of the scene, and fails to estimate accurate poses even when the background pixels are removed from the data (GNeRF-FG).

While the Present Example successfully recovers camera positions from just 7 total views, COLMAP struggles (e.g., 4.2% success rate) when only given access to a small number of views (e.g., <10) and needs up to 160 views to successfully register most views and estimate their camera poses (e.g., still reaching only 58.9% success rate). As COLMAP may pose only a subset of the provided images, Table 2 reports metrics for a predetermined, arbitrarily chosen camera pair per scene. If COLMAP fails to pose either of these cameras, Table 2 considers pose estimation to have failed and excludes this camera pair from evaluation.

TABLE 2
Explicit Pose Recovery

| Method | # Views | MSE | R² (%) | Success (%) |
|---|---|---|---|---|
| The Present | 7 | 0.08 | 99.9 | [100] |
| Example | 10 | 0.00 | 100.0 | 4.2 |
| COLMAP | 80 | 0.07 | 99.7 | 29.5 |
| | 160 | 0.38 | 99.1 | 58.9 |
| GNERF | 12 | 29.39 | 46.7 | [100] |
| | 150 | 9.24 | 83.1 | [100] |
| GNERF-FG* | 150 | 4.05 | 92.7 | [100] |

*GNERF with background pixels removed

Further example test results are provided in Sajjadi et al., RUST: Latent Neural Scene Representations from Unposed Imagery, arxiv.org (24 Mar. 2023), https://arxiv.org/pdf/2211.14306v2.pdf, which is hereby incorporated by reference herein in its entirety.

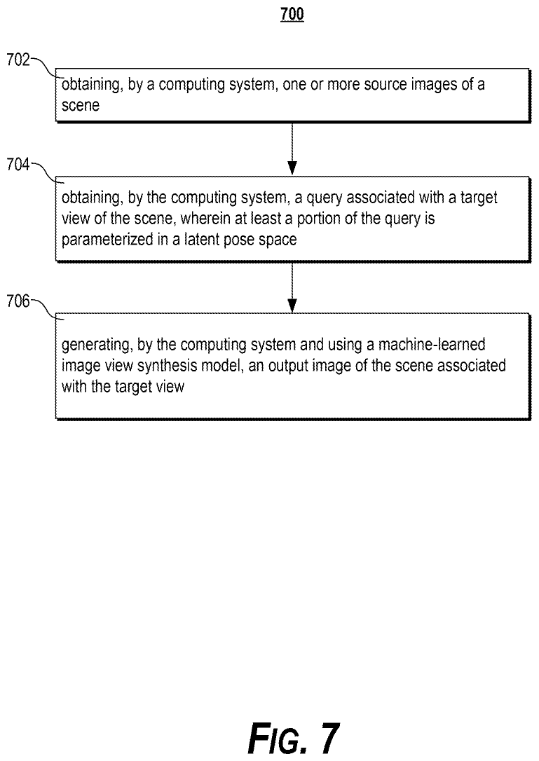

FIG. 7 depicts a flowchart of a method 700 for performing image view synthesis according to example aspects of the present disclosure. One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models.

FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining one or more source images of a scene. For example, a computing system can obtain source images 104 of scene 102. The computing system can obtain source images 104 from a data store of images.

The computing system can obtain source images 104 using an imaging sensor. For example, a mobile device can use an imaging sensor to capture an image for source images 104. In some implementations, example method 700 can include obtaining, by the computing system, the one or more source images of an environment from an imaging sensor of a computing device in the environment. The environment can include scene 102. The computing device can be part of a robotic system that controls a motion of the robotic system.

At 704, example method 700 can include obtaining a query associated with a target view of the scene. At least a portion of the query can be parameterized in a latent pose space. For example, latent pose data 110 can include one or more values that describe a pose value associated with a target view in a latent pose space. The query can include latent pose data 110. The query can include a location indicator that indicates a respective portion of an output image for which the system is generating image data.

At 706, example method 700 can include generating, using a machine-learned image view synthesis model, an output image of the scene associated with the target view. For example, an image view synthesis model 106 can process the query based on source images 104 to generate an output image 112.

In some implementations of example method 700, the image view synthesis model can be learned by reconstructing, using the machine-learned image view synthesis model, training target views of training scenes from training source images. In some implementations of example method 700, the latent pose space can be learned by reconstructing, using the machine-learned image view synthesis model, training target views of training scenes from training source images. The latent pose space can be learned jointly with the image view synthesis model. For instance, a model trainer 214 can evaluate output image 112 against a ground truth training target image 206 using a loss function (e.g., a reconstruction loss, a perceptual loss, etc.). Update gradients can flow to or through pose estimator 208. Update gradients can flow to or through the image view synthesis model. Updates to the image view synthesis model can cause the image view synthesis model or pose estimator 208 to learn to associate scene information in a manner such that latent pose data 110 can recall relevant information for reconstructing the target view.

In some implementations of example method 700, the latent pose space can be learned by generating, using a machine-learned pose estimator model, latent pose values respectively associated with the training target views. For example, during training, a portion of a training target image can be fed to a pose estimator model (e.g., of pose estimator 208) that can generate a latent pose value for latent pose data 110. During an update, the pose estimator model can be updated to learn structured associations between image data and a view associated with the image data.

In some implementations of example method 700, the latent pose values can be used by the machine-learned image view synthesis model to reconstruct the training target views. For instance, the machine-learned image view synthesis model can use the latent pose values to query a stored representation of the scene to extract information from the representation that is relevant to the target view. In an example, the machine-learned image view synthesis model can be configured to generate a latent scene representation and process the latent scene representation in view of the query to obtain the output image. For example, the machine-learned image view synthesis model can cross-attend over the latent scene representation using the query.

In some implementations of example method 700, the latent scene representation can be generated by performing, using the machine-learned image view synthesis model, self-attention over image features extracted from the source images. For example, example method 700 can include performing, using the machine-learned image view synthesis model, self-attention over image features extracted from the source images to generate a latent scene representation. For instance, the latent scene representation can be or include a set of elements generated using one or more transformer blocks.

In some implementations of example method 700, example method 700 can include obtaining training source images of a training scene. The training source images can be associated with a training target image associated with a training target view of the training scene. For instance, a training target image can be a held-out image from a set of training source images. The training target image can be an image having a viewpoint included within viewpoints represented in the training source images.

In some implementations of example method 700, example method 700 can include generating, using a machine-learned pose estimator model, one or more latent pose values associated with the training target view. For example, pose estimator 208 can generate latent pose data 210 by processing at least a portion of a training target image.

In some implementations of example method 700, example method 700 can include generating, using the machine-learned image view synthesis model, a training output image associated with the training target view. For example, image view synthesis model 106 can process latent pose data 210 and a latent scene representation to generate the training output image.

In some implementations of example method 700, example method 700 can include training, based on a comparison of the training output image and the training target image, at least one of the machine-learned pose estimator model or the machine-learned image view synthesis model. or instance, a model trainer 214 can evaluate output image 112 against a ground truth training target image 206 using a loss function (e.g., a reconstruction loss, a perceptual loss, etc.). Update gradients can flow to or through pose estimator 208. Update gradients can flow to or through the image view synthesis model. Updates to the image view synthesis model can cause the image view synthesis model or pose estimator 208 to learn to associate scene information in a manner such that latent pose data 110 can recall relevant information for reconstructing the target view.

In some implementations of example method 700, the machine-learned image view synthesis model can be trained for at least one cycle without explicit ground-truth pose data. For example, example implementations of an image view synthesis model according to the present disclosure can operate without any ground truth pose data.

In some implementations of example method 700, example method 700 can include, for a respective portion of the output image, determining a respective location-indexed query based on the query and an index value for the respective portion. For example, a query can include a location indicator that points to a position of the output image for which the image view synthesis model is generating image data. For example, the query can include a coordinate of a pixel of the output image. In this manner, for instance, the query can be indexed to a particular location of the output image.

In some implementations of example method 700, example method 700 can include, for a respective portion of the output image, determining, based on the respective location-indexed query, relevant features of the latent scene representation for generating the respective portion. In some implementations of example method 700, example method 700 can include, for a respective portion of the output image, generating, based on the relevant features, the respective portion.

In some implementations of example method 700, the machine-learned pose estimator model can be configured to process a portion of the training target image and at least a portion of the latent scene representation to generate the latent pose value. In some implementations of example method 700, the machine-learned pose estimator model attends over a selected subset of the set of image features that corresponds to a reference view of the one or more source images. For example, pose estimator 208 can process a subset of the elements in the latent scene representation that are associated with a reference view or image (e.g., a first image or other arbitrarily selected anchor image).

In some implementations of example method 700, the machine-learned pose estimator model includes an encoder configured to attend over the set of image features. In some implementations of example method 700, the machine-learned image view synthesis model can generate the respective portion using a decoder that cross-attends over the latent scene representation based on the respective location-indexed query. The encoder can include one or more transformer-based attention layers. The decoder can include one or more transformer-based attention layers.

In some implementations of example method 700, at least a portion of the query (e.g., a latent pose) can be obtained using a view navigator that provides an interactive interface for mapping pose inputs to the latent pose space. For example, a view navigator can include a user interface that renders graphical indicators of one or axes in the latent pose space. For instance, a user interface can include an element that renders a plurality of output images generated that vary only in a latent pose that is adjusted along an axis of the latent pose space. In this manner, for instance, the plurality of output images can graphically represent a traversal of the latent pose space. The traversal can cause the plurality of output images to reflect a consistent change in view that corresponds to a change in a camera pose, such as a roll, a translation, a rotation, a tilt, etc. The plurality of output images can be animated to emphasize the change in camera pose.

In some implementations of example method 700, the view navigator maps one or more interactive input elements to one or more principal axes of the latent pose space that correspond to interpretable pose controls. For example, the view navigator can determine (automatically or based on user input) that traversal of the latent pose space along an axis (a principal axis, a different axis, etc.) can correspond to a camera movement. The view navigator can provide an interactive input element that facilitates user control of the view along that axis for obtaining new output images.

In some implementations of example method 700, example method 700 can include obtaining latent pose values for each of a plurality of helper images. For instance, helper images can be processed by a pose estimator to obtain latent pose values associated with the helper images. In some implementations of example method 700, example method 700 can include obtaining one or more target latent pose values for a target view by interpolating between the latent pose values of the helper images. For example, a system might not directly receive an input that designates a desired input view. The system can receive instructions to generate new views that interpolate between existing known views (e.g., for smoothing between image frames, such as for artificial slow-motion footage, to augment a training dataset with more example images, to improve object tracking between frames, etc.). The system can generate a trajectory between latent pose endpoints associated with the helper images and generate new views that lie along the trajectory.

In some implementations of example method 700, the view navigator can be configured to explore the latent pose space and determine one or more control vectors that correspond to interpretable pose controls. For example, the view navigator can generate a range of output images and compare them to identify changes between images. The view navigator can infer (e.g., using a machine-learned model) changes that appear consistent with explicit camera pose parameters, such as position, rotation, tilt, translation, etc. The view navigator can associate interpretable pose characteristics to axes of the latent pose space. The view navigator can associate interpretable pose characteristics to natural axes of the latent pose space (e.g., that correspond to the dimensions of the latent pose space). The view navigator can associate interpretable pose characteristics to transformed axes of the latent pose space (e.g., axes formed by transforming the latent pose space according to a learned transform).

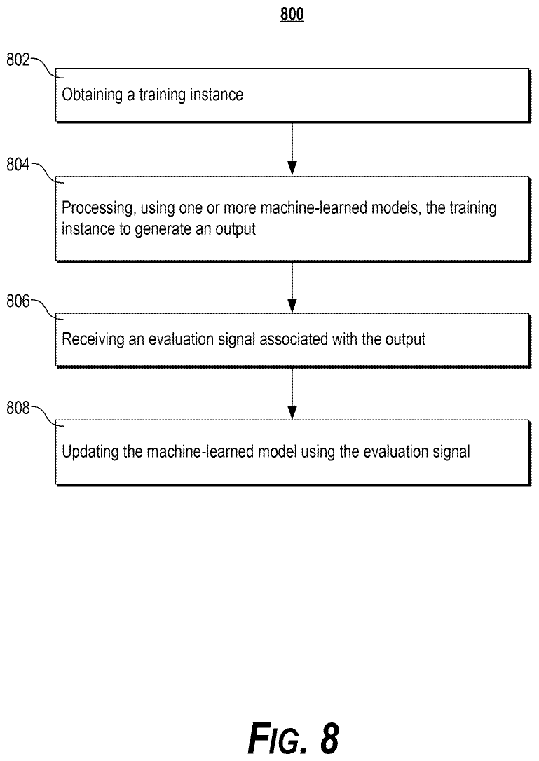

FIG. 8 depicts a flowchart of a method 800 for training one or more machine-learned models according to aspects of the present disclosure. For instance, an example machine-learned model can include an image view synthesis model 106, a pose estimator 208, etc.

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types. In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

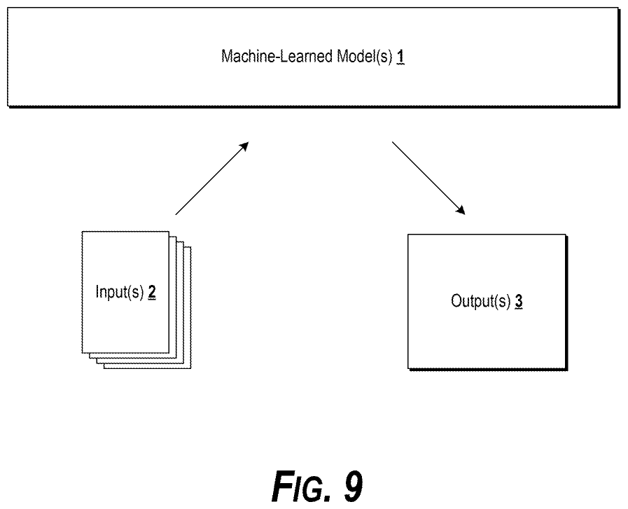

FIG. 9 is a block diagram of an example processing flow for using machine-learned model(s) 1 to process input(s) 2 to generate output(s) 3. An image view synthesis model 106, a pose estimator 208, a view navigator 502, etc. can all be or include a machine-learned model 1.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

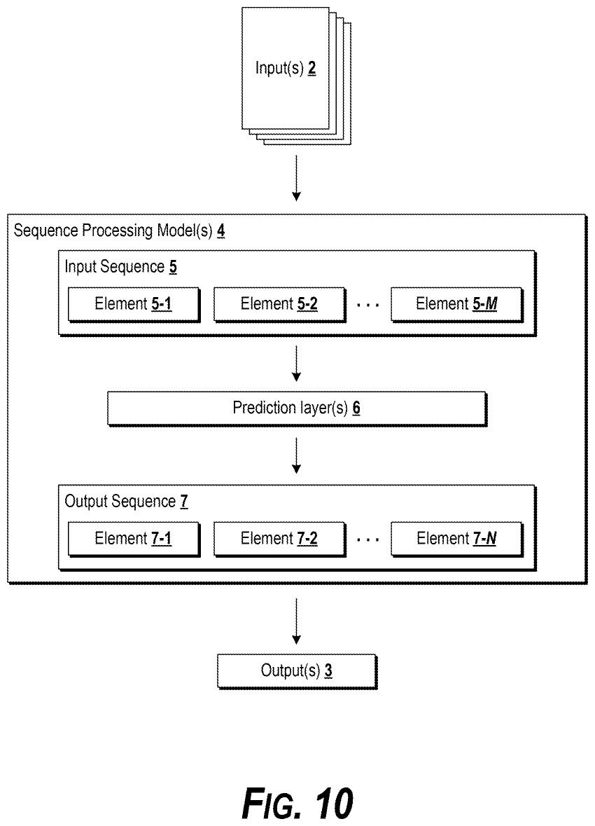

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

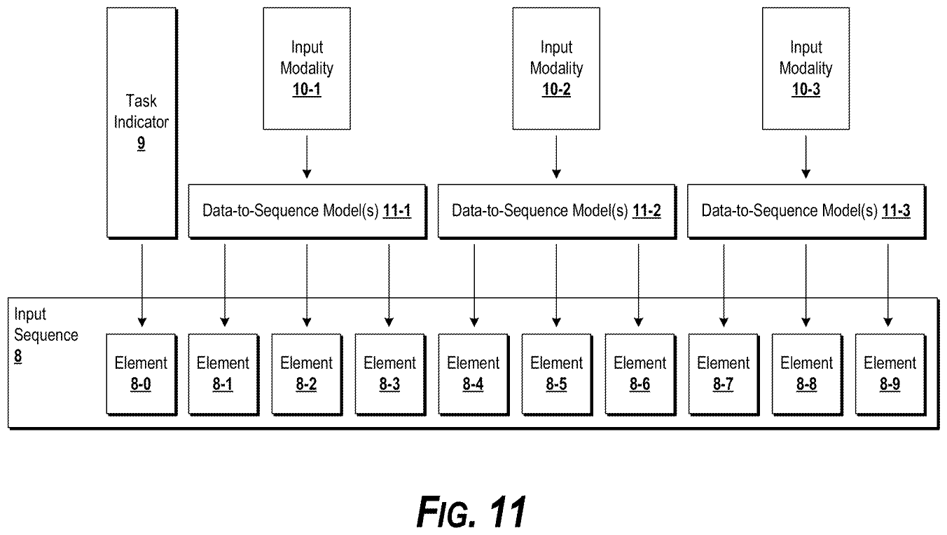

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

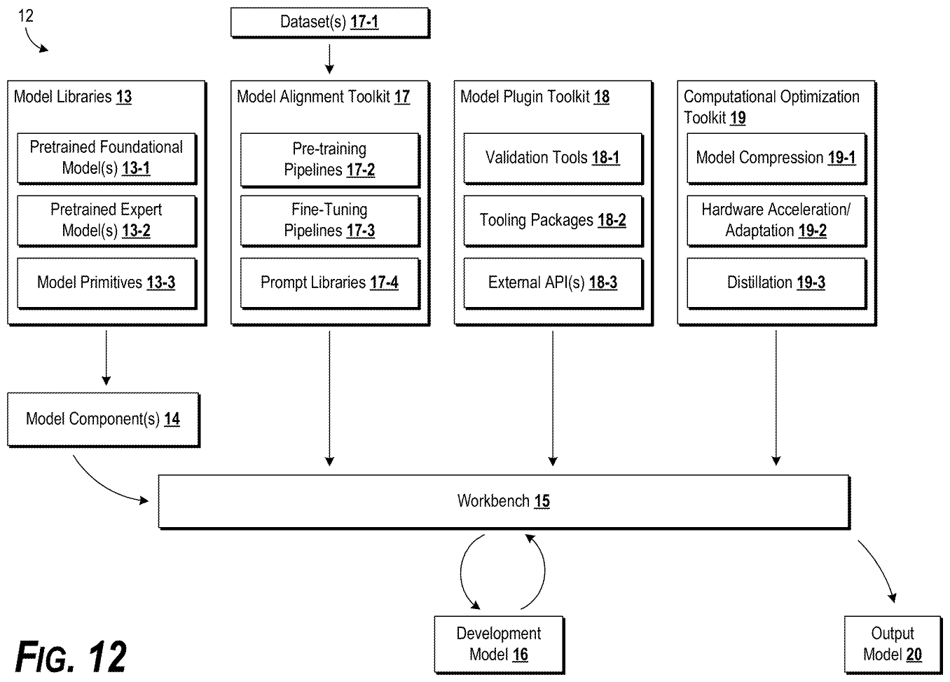

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

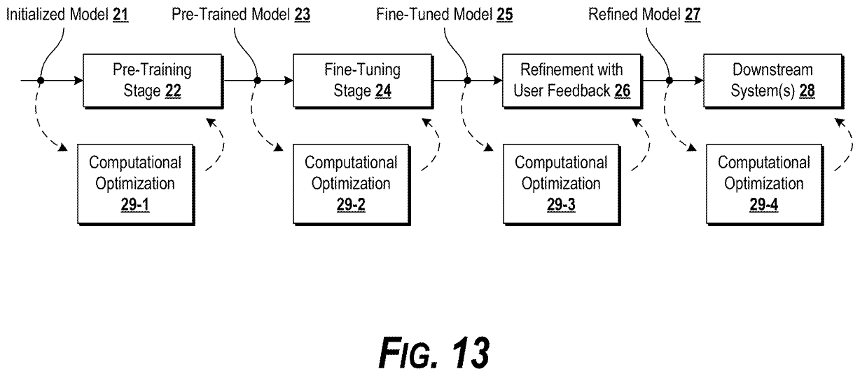

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

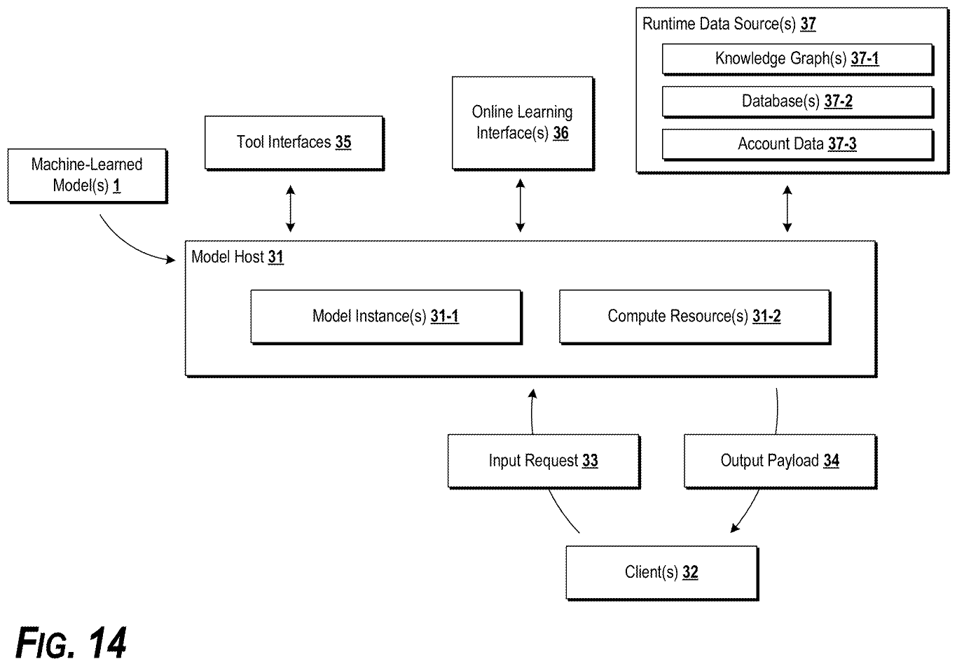

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily eached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include eached intermediate states of active or inactive model(s) used to accelerate inference of those models. For instance, an inference session with a particular model may generate significant amounts of computational results that can be re-used for future inference runs (e.g., using a KV eache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

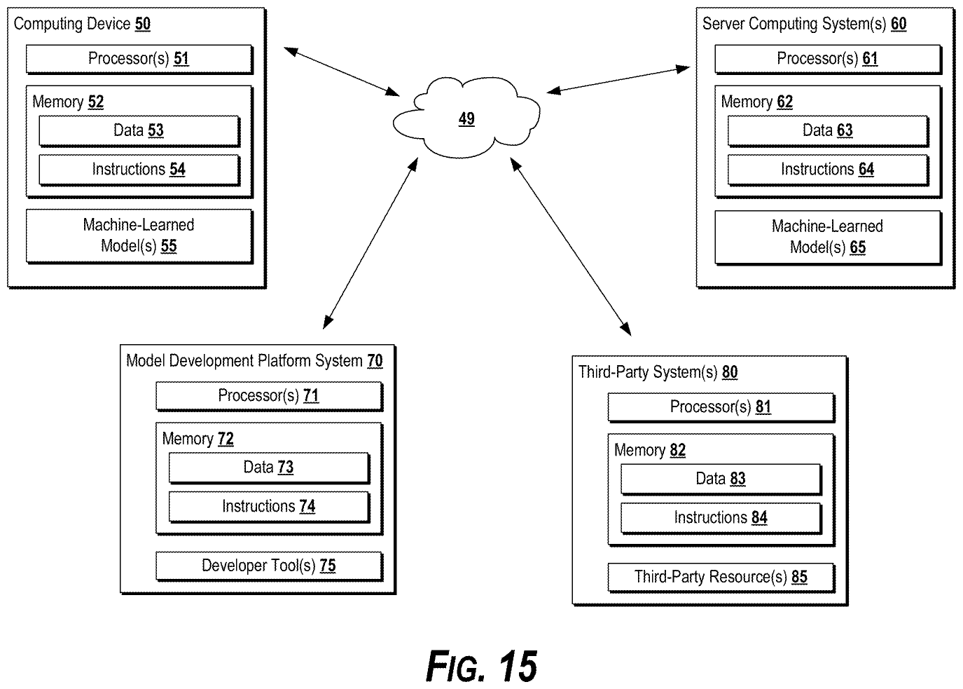

FIG. 15 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 15 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 15 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

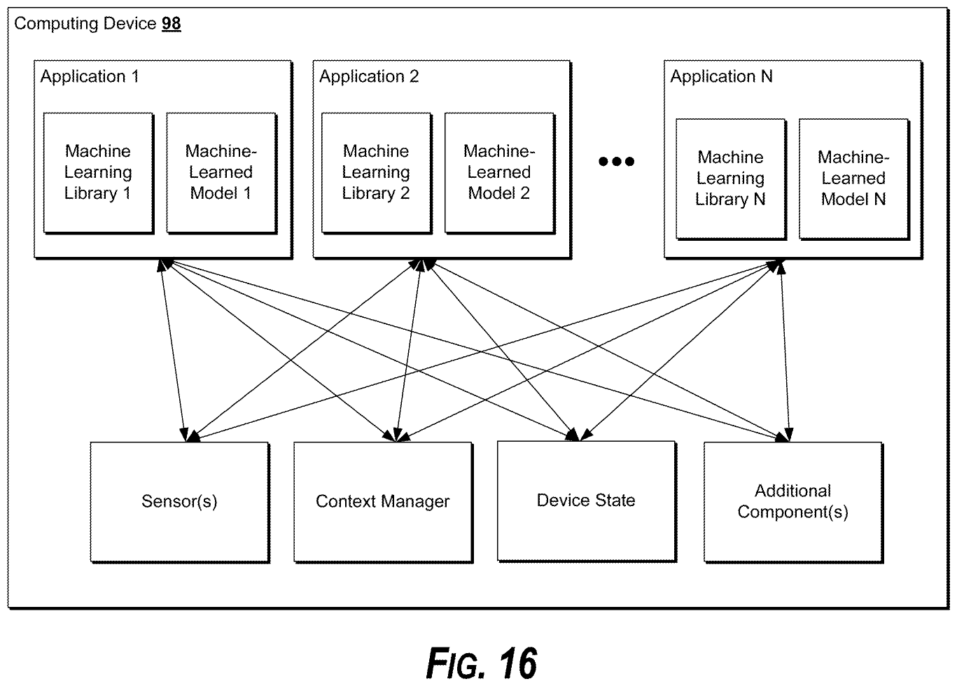

FIG. 16 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 16, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

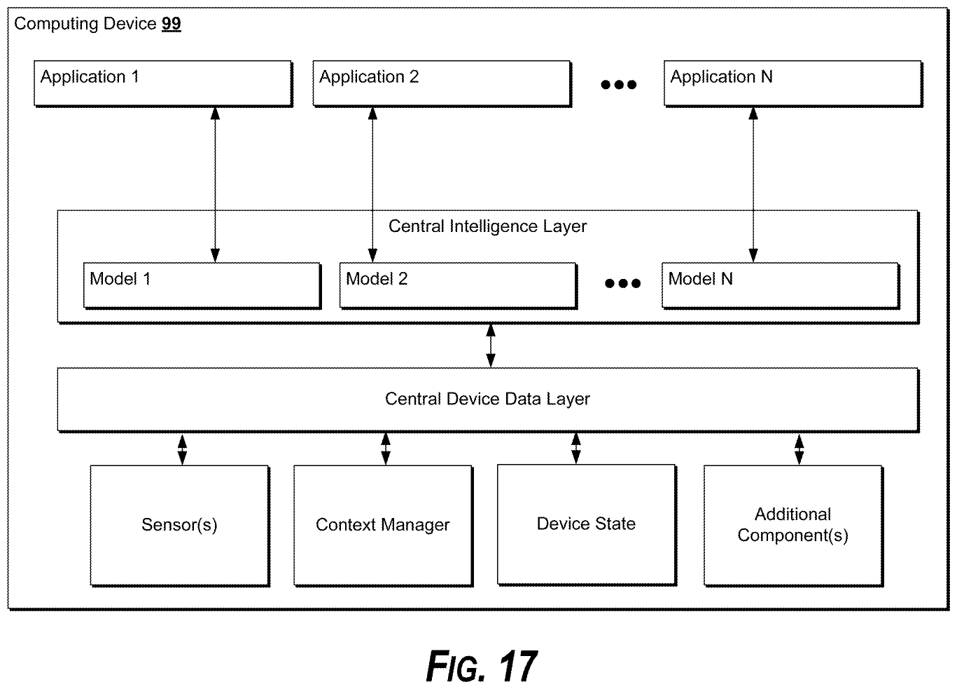

FIG. 17 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 17, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 17, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for image view synthesis, the method comprising:
obtaining, by a computing system, one or more source images of a scene;
obtaining, by the computing system, a query associated with a target view of the scene, wherein at least a portion of the query is parameterized in a latent pose space; and
generating, by the computing system and using a machine-learned image view synthesis model, an output image of the scene associated with the target view.

2. The computer-implemented method of claim 1, wherein the latent pose space was learned by reconstructing, using the machine-learned image view synthesis model, training target views of training scenes from training source images.

3. The computer-implemented method of claim 2, wherein the latent pose space was learned by generating, using a machine-learned pose estimator model, latent pose values respectively associated with the training target views.

4. The computer-implemented method of claim 3, wherein the latent pose values were used by the machine-learned image view synthesis model to reconstruct the training target views.

5. The computer-implemented method of claim 1, comprising:
obtaining, by the computing system, training source images of a training scene, wherein the training source images are associated with a training target image associated with a training target view of the training scene;
generating, by the computing system and using a machine-learned pose estimator model, one or more latent pose values associated with the training target view;
generating, by the computing system and using the machine-learned image view synthesis model, a training output image associated with the training target view; and
training, by the computing system and based on a comparison of the training output image and the training target image, at least one of the machine-learned pose estimator model or the machine-learned image view synthesis model.

6. The computer-implemented method of claim 1, wherein the machine-learned image view synthesis model is trained for at least one cycle without explicit ground-truth pose data.

7. The computer-implemented method of claim 1, wherein the machine-learned image view synthesis model is configured to generate a latent scene representation from the latent scene representation and process the latent scene representation in view of the query to obtain the output image.

8. The computer-implemented method of claim 7, wherein the latent scene representation is generated by performing, using the machine-learned image view synthesis model, self-attention over image features extracted from the source images.

9. The computer-implemented method of claim 1, comprising, for a respective portion of the output image:
determining, by the computing system, a respective location-indexed query based on the query and an index value for the respective portion;
determining, by the computing system and based on the respective location-indexed query, relevant features of a latent scene representation for generating the respective portion; and
generating, based on the relevant features, the respective portion;
wherein the machine-learned image view synthesis model generates the respective portion using a decoding transformer that cross-attends over the latent scene representation based on the respective location-indexed query.

10. The computer-implemented method of claim 5, wherein the machine-learned pose estimator model is configured to process the portion of the training target image and at least a portion of a latent scene representation to generate the latent pose value.

11. The computer-implemented method of claim 7, wherein the machine-learned pose estimator model comprises a transformer encoder configured to attend over the latent scene representation.

12. The computer-implemented method of claim 11, wherein the machine-learned pose estimator model attends over a selected subset of the latent scene representation that corresponds to a reference view of the one or more source images.

13. The computer-implemented method of claim 1, wherein the query is obtained using a view navigator that provides an interactive interface for mapping pose inputs to the latent pose space.

14. The computer-implemented method of claim 13, wherein the view navigator maps one or more interactive input elements to one or more principal axes of the latent pose space that correspond to interpretable pose controls.

15. The computer-implemented method of claim 1, comprising:
obtaining, by the computing system, latent pose values for each of a plurality of helper images; and
obtaining, by the computing system, one or more target latent pose values for a target view by interpolating between the latent pose values of the helper images.

16. The computer-implemented method of claim 13, wherein the view navigator is configured to explore the latent pose space and determine one or more control vectors that correspond to interpretable pose controls.

17. The computer-implemented method of claim 1, comprising:
obtaining, by the computing system, the one or more source images of an environment from an imaging sensor of a computing device in the environment, wherein the environment comprises the scene; and
generating the output image using the computing device.

18. The computer-implemented method of claim 17, wherein the computing device is part of a robotic system that controls a motion of the robotic system based on the output image.

19. One or more non-transitory computer-readable media storing instructions that are executable by one or more processors to cause a computing system perform operations, the operations comprising:
obtaining one or more source images of a scene;
obtaining a query associated with a target view of the scene, wherein at least a portion of the query is parameterized in a latent pose space; and
generating, using a machine-learned image view synthesis model, an output image of the scene associated with the target view.

20. A computing system comprising:
one or more processors; and
one or more non-transitory computer-readable media storing instructions that are executable by the one or more processors to cause the computing system to perform operations, the operations comprising:
obtaining one or more source images of a scene;
obtaining a query associated with a target view of the scene, wherein at least a portion of the query is parameterized in a latent pose space; and
generating, using a machine-learned image view synthesis model, an output image of the scene associated with the target view.
